(19) United States
(12) Patent Application Publication
(10) Pub. No.: US 2009/0130252 A1
(43) Pub. Date: May 21, 2009

(54) REFRIGERATED, CHEMICALLY-LEAVENED DOUGH IN LOW PRESSURE PACKAGE

(76) Inventors: David J. Domingues, Plymouth, MN (US); Dennis A. Lonergan, Medina, MN (US)

Correspondence Address: GENERAL MILLS, INC., P.O. BOX 1113, MINNEAPOLIS, MN, 55440, US

(21) Appl. No.: 11/577,886

(22) PCT Filed: Oct. 28, 2005
(86) PCT No.: PCT/US05/39187

§ 371 Date: Apr. 25, 2007

Related U.S. Application Data
(60) Provisional application No. 60/623,427, filed on Oct. 29, 2004.

(51) Int. Cl. A21D 8/02; B65D 81/20

(52) U.S. Cl. 426/8; 426/118; 426/18

(57) ABSTRACT

Described are doughs that include a chemical leavening agent and conditioner, that can be stored at refrigerated conditions, and that can be baked to desired baked specific volume.

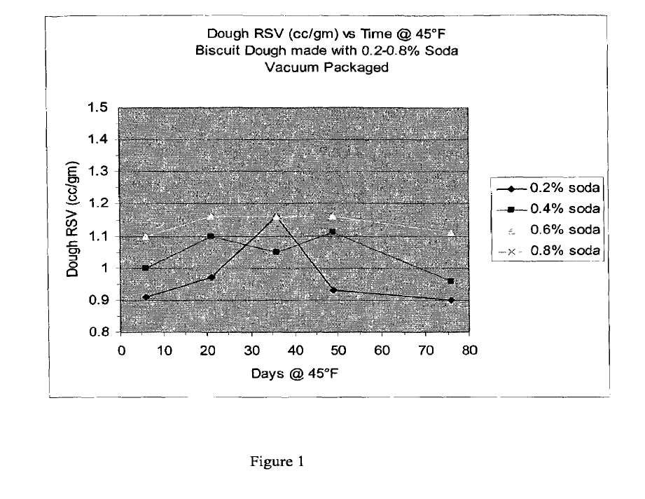

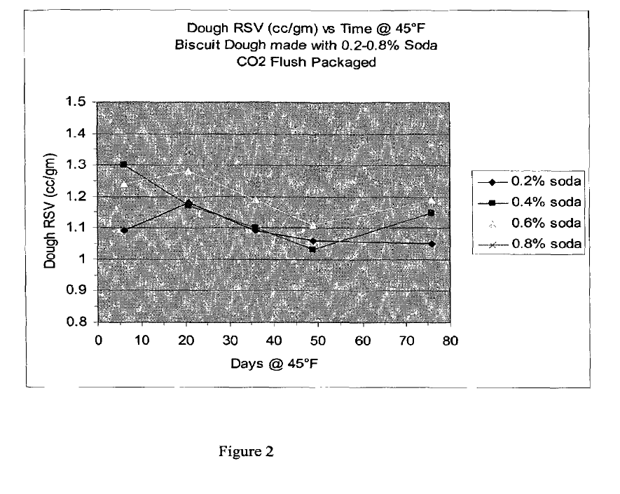

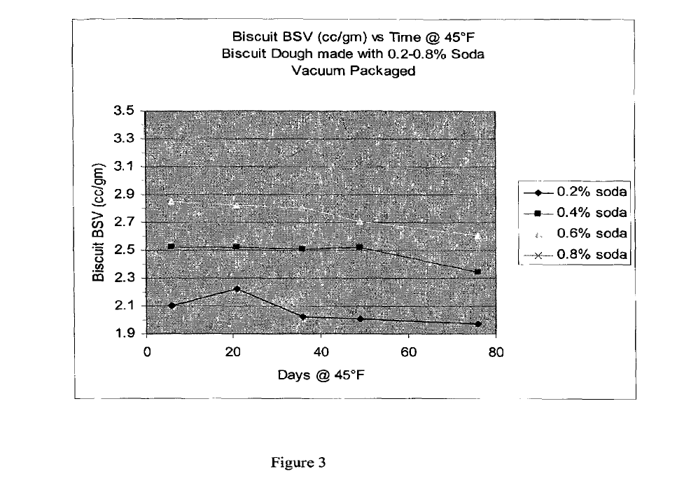

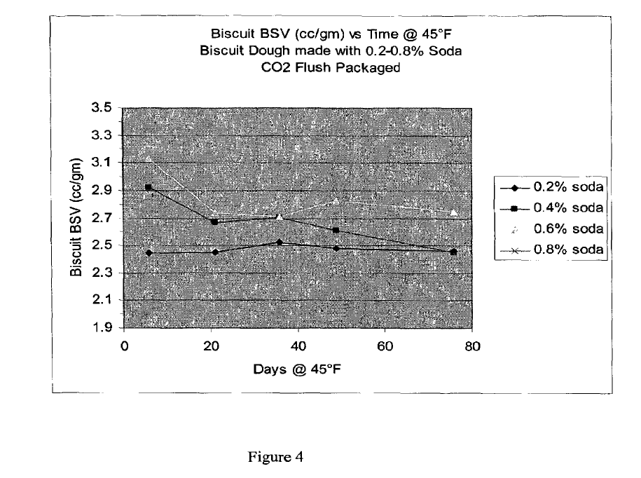

### FIELD OF THE INVENTION

The invention relates to refrigerator-stable, chemically-leavened dough compositions, their related dough products, and methods for preparing the same.

### BACKGROUND

Today's commercial and consumer dough products are designed to accommodate consumer preferences in terms of convenience of use, storage stability, and organoleptic properties such as taste, texture, aroma, and color. One popular type of consumer dough product is the class of refrigerator-stable, chemically-leavened, dough products, a single example being refrigerated soda biscuits. These dough products are leavened substantially by the action of chemical leavening agents, as opposed to yeast, and they can be packaged to be stable over certain periods of time at refrigerated conditions.

Chemically-leavened doughs contain chemical leavening agents in combination with typical dough ingredients such as flour, water, fat (e.g., solid fat or a liquid oil), and optional flavorants (e.g., salt or sweeteners) or other additives, which are combined to form a dough mass. As opposed to yeast-leavened doughs, a chemically-leavened dough is not leavened by the action of yeast. Instead, a chemically-leavened dough is leavened by the reaction between chemical leavening agents that, when in contact, produce a leavening gas such as carbon dioxide. This chemical reaction, and the resultant leavening of the dough, can occur at various times, such as during preparation of a dough, during refrigerated storage, or during baking. As opposed to yeast-leavened doughs, chemically-leavened doughs do not typically require a time-consuming “proofing” step before cooking, during which a dough is rested to allow yeast to metabolize. As such, a chemically-leavened dough composition can offer improved convenience compared to yeast-leavened dough compositions.

Consumers also appreciate the convenience of refrigerator-stable dough compositions, based on the ability to store a refrigerated dough product, to conveniently prepare the product at any convenient time. Refrigerated doughs should maintain a stable and fresh appearance during storage, including, e.g., desired coloration, aroma, and size upon removal from frozen storage, as well as the ability to be cooked to produce a desired dough product following storage. The cooked dough product should exhibit a balance of properties comparable to cooked doughs prepared without having been refrigerated, such as desired taste, aroma, texture, leavening properties (e.g., raw and baked specific volumes), and color. In practice, it can be a challenge to produce doughs that can be refrigerated for extended periods and then cooked to qualities that are similar to doughs that have not been stored at refrigerated conditions. For example, chemically leavened doughs may suffer undesired changes in color (e.g., discoloration) or size (e.g., due to unwanted leavening) during refrigerated storage, or may lose the ability to be cooked to a desired size, flavor, texture, or color. Consequently, an ongoing need exists for chemically-leavened refrigerated dough products that exhibit desired uncooked and cooked properties.

### SUMMARY

The invention involves chemically-leavened dough compositions that contain chemical leavening agents and conditioner, and that can be stored at refrigerated conditions in a low pressure package. The dough compositions include a conditioning agent that improves leavening properties of the dough during baking, in combination with acidic and basic chemical leavening agents that prevent excessive expansion of the dough composition during processing and refrigerated storage, e.g., that maintain the raw specific volume of the dough composition at a relatively low level during refrigerated storage such as a raw specific volume not in excess of 1.5 cubic centimeters per gram.

Certain past bread-making techniques have involved a practice of leavening a dough composition to some degree prior to baking, to produce or enlarge bubbles in a dough matrix that increase raw specific volume of the dough prior to baking. The same bubbles can also expand during cooking e.g., (baking) to further increase the specific volume of the dough.

An increased raw specific volume, which can increase a baked specific volume, may also have drawbacks, however. These drawbacks may include a requirement for increased package size, added complication in formulating a dough composition with respect to selection of chemical leavening agents, or added complication in packaging or processing designs, to achieve the desired raw specific volume during processing or packaging and prior to cooking.

According to the invention, a conditioning agent can be included in a chemically leavened, refrigerated dough composition, to reduce the need for leavening the dough composition prior to cooking. Specifically, a conditioning agent can be used to improve gas-holding capability of a dough composition, which can result in improved leavening of the dough composition during baking compared to a similar dough that does not contain a conditioning agent. This means that as compared to other dough compositions, doughs of the invention can experience a reduced amount of leavening before baking (e.g., the raw dough can exhibit a relatively lower specific volume during processing and refrigerated storage), and the dough composition is still able to achieve at least comparable cooked (e.g., baked) specific volume. As an example, a dough composition of the invention, including a conditioning agent, can be prepared to exhibit a raw specific volume in the range from about 0.9 to 1.5 cubic centimeters per gram (cc/g), and can be cooked (e.g., baked) to a specific volume that is at least 2.5 cc/g, e.g., from 2.5 cc/g to 3.5 cc/g.

Chemically-leavened dough compositions according to the invention can be packaged in low-pressure packaging, optionally while frozen and optionally with vacuum. In particular embodiments, a frozen dough can be placed in a flexible package that has sufficient volume to allow a degree of expansion of the dough composition within the flexible package, and vacuum can be used to remove excess gases from the package when sealed. The dough can thaw in the package. During refrigerated storage, any leavening of the dough that occurs within the package can occur in a way that allows the dough to expand to the full volume of the package, without producing excessive pressure inside the package. In specific embodiments, the result can be a packaged dough product having an internal pressure that remains at approximately 1 atmosphere (absolute) during refrigerated storage, e.g., for up to or exceeding 40 days of refrigerated storage, wherein the packaged dough product that contains little or no headspace produced by gas development.

Thus, certain embodiments of the invention include a refrigerated, chemically leavened dough composition packaged in a low pressure flexible package, optionally with little or no headspace. A low pressure package can mean a package that is substantially air tight, with an internal pressure that is typically less than 15 psia (pounds per square inch, absolute). Examples of low pressure packages include chubs and pouches that do not exhibit a pressurized interior. Low pressure packages specifically exclude pressurized cans and canisters, e.g., of cardboard, that contain dough products at an internal pressure of at least 15 psig. Optionally, if desired or necessary, the low pressure package may include a pressure relief valve to allow gas to escape the package during refrigerated storage.

An aspect of the invention relates to a refrigerated dough product that includes comprising a raw chemically-leavened dough composition in a low pressure package. The dough composition contains chemical leavening agent and conditioning agent. The dough composition has a raw specific volume in the range from 0.9 to 1.5 cubic centimeter per gram and can be cooked to a specific volume of at least 2.5 cubic centimeter per gram.

Another aspect of the invention relates to a method of providing a dough product. The method includes providing a raw chemically-leavened dough composition that contains chemical leavening agent and conditioner; placing the raw dough composition in a low pressure package; storing the dough composition at a refrigerated storage temperature, wherein the dough exhibits a raw specific volume during refrigerated storage that does not exceed 1.5 cubic centimeters per gram; and cooking the dough composition to a specific volume of at least 2.5 cubic centimeter per gram.

### DETAILED DESCRIPTION

Dough compositions according to the invention are chemically-leavened (or “chemically-leavenable”) dough compositions that leaven to a substantial extent by the action of chemical ingredients that react to produce a leavening gas. Typically, the dough ingredients include a basic chemical leavening agent and an acidic chemical leavening agent, the two of which react to produce carbon dioxide that when retained by the dough matrix causes the dough to expand or “leaven.” Chemically-leavened doughs can be contrasted to dough formulations that are substantially leavened due to the action of yeast as a leavening agent, i.e., by metabolic action of yeast on a substrate to produce carbon dioxide. While doughs of the invention can include yeast, e.g., as a flavoring agent, certain dough compositions of the invention do not include yeast as a leavening agent.

Specific examples of dough compositions useful according to the invention include dough compositions referred to as “non-developed” dough compositions. The degree of development of a dough (as in a “developed” versus a “non-developed” dough) generally refers to the strength of a dough's matrix, as the strength relates to the degree of development of gluten (protein) in a dough matrix. During processing of a dough composition, gluten can be caused or allowed to interact or react and “develop” a dough composition in a way that increases the stiffness, strength, and elasticity of the dough. Doughs commonly referred to as “developed” doughs are generally understood to include doughs that have a relatively highly-developed gluten matrix structure; a stiff, elastic rheology; and (due to the stiff, elastic matrix) are well able to form bubbles or cells that can stretch without breaking to hold a leavening gas while the dough expands, leavens, or rises, prior to or during cooking (e.g., baking). Features that are sometimes associated with a developed dough, in addition to a stiff, elastic rheology, include a liquid content, e.g., water content, that is relatively high compared to non-developed doughs; a sufficient (e.g., relatively high) protein content to allow for a highly-developed structure; optionally, processing steps that include time to allow the dough ingredients (e.g., gluten) to interact and “develop” to strengthen the dough; and on average a baked specific volume that is relatively higher than non-developed doughs. Oftentimes, developed doughs are yeast-leavened, but may be chemically leavened. Examples of specific types of doughs that can be considered to be developed doughs include doughs for pizza crust, breads (loaves, dinner rolls, baguettes, bread sticks), raised donuts, cinnamon rolls, croissants, Danishes, pretzels, etc.

As compared to “developed” doughs, doughs commonly referred to as non-developed (or “un-developed” or “under-developed”) have a relatively less developed (“undeveloped”) dough matrix that gives the dough a relatively non-elastic rheology, reduced strength, and reduced gas-holding capacity, compared to more developed doughs. Being less elastic than a developed dough and exhibiting a reduced gas-holding capacity, non-developed doughs, on average, exhibit relatively lower raw and baked specific volumes. Examples of non-developed types of doughs include cookies, cakes, cake donuts, muffins, and other batter-type doughs such as brownies, biscuits, etc.

Chemically-leavened, non-developed, dough compositions of the invention can be prepared to include ingredients generally known in the dough and bread-making arts, such as flour, a liquid component such as oil or water, chemical leavening agents, fat (solid or liquid), and optionally additional ingredients such as salt, sweeteners, dairy products, egg products, processing aids, particulates, yeast as a flavorant, other flavorings, and the like. Exemplary compositions do not include yeast as a leavening agent, and such doughs are leavened based on the action of the chemical leavening agents.

Acidic chemical leavening agents (or “acidic agents”) that may be useful according to the invention include those generally known in the dough and bread-making arts. Various types of acidic agents may exhibit differing solubilities based on temperature, and may or may not be encapsulated. Examples of acidic agents include sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactone (GDL), dimagnesium phosphate (DMP), as well as a variety of others. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP).

According to certain embodiments of the invention, an acidic chemical leavening agent can be selected, in combination with other ingredients, to provide a dough composition with desired refrigerated-storage stability as described herein, e.g., including one or a combination of desired, taste, texture, and desired carbon dioxide production and leavening properties during refrigerated storage and baking. According to certain such embodiments, an acidic chemical leavening agent can be of a type that is only slightly soluble in an aqueous component of a dough composition at processing and refrigerated storage temperatures, which include temperatures above freezing (32 F) and up to room temperature (e.g., 70 F), e.g., from 35 to 45 degrees Fahrenheit for refrigerated storage. An acidic agent having such relatively low solubility can contribute to storage stability of a dough composition of the invention, for example by preventing dissolution of the acidic agent during refrigerated storage. By preventing dissolution during refrigeration, the acidic agent is inhibited from reacting with basic agent to produce carbon dioxide, which carbon dioxide can cause an undesired degree of expansion of the dough, carbon dioxide evolution into a sealed package, or both. At higher temperatures such as those that occur during baking, such an acidic agent can dissolve, react with a basic agent, and contribute to expansion and leavening of the dough composition.

Particularly useful acidic chemical leavening agents include SALP and relatively slower reacting (relatively insoluble) SAPP (e.g., low activity SAPP, for example SAPP-RD-1, 26, 28) and other acidic agents that exhibit solubility behavior similar to SALP and low activity SAPP such as dimagnesium phosphate (DMP).

The amount of acidic chemical leavening agent used in a dough composition can be an amount sufficient to provide desired dough properties as described herein, including—considering, e.g., the solubility of an acidic agent and whether the agent is encapsulated—an amount that provides a dough composition having refrigerated storage stability as discussed herein, including desired carbon dioxide evolution and leavening properties during storage and upon baking.

Exemplary amounts of acidic agent can be included to provide a raw specific volume in the range from 0.9 to 1.5 grams per cubic centimeter, during refrigerated storage, as well as a desired baked specific volume upon baking, such as a baked specific volume in the range from 2.5 to 3.5 cc/g. A typical amount of acidic agent such as SALP may be in the range from about 0.2 to about 2 weight percent acidic agent based on total weight dough composition, e.g., from about 0.25 to about 1.5 weight percent. These amounts of ingredients, and amounts of other ingredients as presented herein, are based on total weight of a dough composition unless otherwise noted. Also, amounts of acidic (or basic) chemical leavening agents agent identified throughout the present application and claims do not including encapsulating agent unless otherwise noted.

The dough composition also includes basic chemical leavening agent, which may or may not be encapsulated. Useful basic chemical leavening agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic chemical leavening agents are generally freely soluble in an aqueous component of a dough composition at processing and refrigerated storage temperatures.

The amount of basic chemical leavening agent used in a dough composition may be sufficient to react with the included acidic chemical leavening agent to release a desired amount of gas for leavening, e.g., during baking, thereby causing a desired degree of expansion of the dough product. Amounts can be selected, for example, as being sufficient to neutralize an amount of acid that is present in the dough composition. According to embodiments of the invention, an amount of basic agent can be used that, in combination with other ingredients of a dough composition, provides desirably low leavening of a dough composition during processing and refrigerated storage as described herein, and that also provides desired amount of leavening during baking.

Exemplary amounts of basic agent can be included to provide a raw specific volume in the range from about 0.95 to 1.5 grams per cubic centimeter during refrigerated storage, as well as a desired baked specific volume upon baking, such as a baked specific volume in the range from 2.5 to 3.5 cc/g. Specific exemplary amount of a basic chemical leavening agent such as sodium bicarbonate may be in the range from about 0.1 to 2 weight percent basic chemical leavening agent based on total weight dough composition, including the range from about 0.2 to 1 weight percent based on total weight dough composition.

Acidic or basic chemical leavening agent for use according to the invention may be encapsulated or non-encapsulated. Accordingly, certain embodiments of the invention can include a non-encapsulated acidic agent (e.g., a low solubility acidic agent such as SALP, SAPP, and the like) in combination with non-encapsulated basic agent. Still, encapsulation of the acidic agent, the basic agent, or both, may be useful. Encapsulated chemical leavening agents are generally known, and can be prepared by methods known in the baking and encapsulation arts.

Dough compositions of the invention include a conditioning agent to improve the gas-holding capabilities of the dough composition during cooking, to in turn increase the baked specific volume of the dough composition. Inclusion of conditioning agent can thereby allow the dough composition to require less expansion or leavening prior to baking, while still achieving a desirably high baked specific volume. Specifically, known bread-making techniques may allow for allowing a dough composition to experience substantial leavening prior to baking, to increase the raw specific volume and in turn a cooked specific volume. According to the invention, the use of a conditioning agent allows for a reduced need for such leavening prior to baking, yet still can produce desired cooked (e.g., baked) specific volume. Because of the improved gas-holding capabilities of the dough resulting from the conditioning agent, a refrigerated dough as described herein can experience greater leavening during baking compared to otherwise similar doughs that, e.g., do not contain a conditioning agent. According to the invention, therefore, less leavening will be needed prior to baking to achieve a similar baked specific volume.

Useful conditioning agents according to the invention include those that are and will be known and understood in the dough and bread-making arts to be useful to improve gas-holding properties of a dough. Examples include chemical agents that function as oxidants or emulsifiers. These agents may improve the gas-holding capability of a raw dough, during baking, by improving rheology (e.g., elasticity) of the dough. Specific examples of conditioning agents include ingredients such as lecithin, mono- and diglycerides, polyglycerol esters, and the like, e.g., diacetylated tartaric esters of monoglyceride (DATEM) and sodium stearoyl-2-lactylate (SSL), ascorbic acid, azodicarbonamide, enzymes such as transglutaminase and various xylanases and amylases, as well as other such similar chemical ingredients that function to improve dough rheology and increase the gas-holding capability of a dough composition during baking, to ultimately result in an increased baked specific volume of the dough upon baking.

The amount of conditioning agent included in a dough composition can be an amount useful to achieve gas-holding properties of a dough composition as described herein, e.g., that produce an increased baked specific volume (from a given raw specific volume) compared to a dough composition that does not include conditioning agent. Useful amounts, in combination with other dough ingredients (e.g., optionally, non-encapsulated basic and non-encapsulated acidic low solubility chemical leavening agents) can result in a dough composition that exhibits raw and baked specific volume properties as described herein. Specific amounts of conditioning agent that will be useful as described, will depend on factors such as the type of conditioning agent, desired raw and cooked leavening properties, and other ingredients and their amounts used in the dough composition. Specific amounts of conditioning agent may be included in a dough composition within any range permissible by law, with exemplary amounts being, e.g., from 0.01 to 0.05, or up to 0.1 weight percent based on flour, depending on the specific conditioning agent being used. Examples include amounts in the range from 0.25-0.5% diacetyl tartaric acid esters of mono- and diglycerides (DATEM), 0.001-0.01% ascorbic acid, 0.01-0.45% azodicarbonamide, and 0.25-0.5% sodium steroyl lactylate based on the total weight of flour present in the formula.

A chemically-leavened dough composition according to the invention can include other dough ingredients as known in the dough and baking arts, or as developed in the future to be useful with chemically-leavened dough compositions. Such ingredients and amounts useful to produce a dough composition as described herein, will be understood by those of skill in the dough and bread-making arts.

A flour component can be any suitable flour or combination of flours, including glutenous and nonglutenous flours, and combinations thereof. The flour or flours can be whole grain flour, flour with the bran and/or germ removed, or combinations thereof. Typically, a non-developed dough composition can include between about 30 and about 50 weight percent flour, e.g., from about 35 to about 45 weight percent flour, based on the total weight of a dough composition.

Examples of liquid components include water, milk, eggs, and oil, or any combination of these, as will be understood to be useful in chemically-leavened (e.g., non-developed) dough compositions. For example, a liquid component for a non-developed dough composition may be water (added as an ingredient and as part of other ingredients), e.g., in an amount in the range from about 15 to 35 weight percent, although amounts outside of this range may also be useful. Water may be added during processing in the form of ice, to control the dough temperature in-process; the amount of any such water used is included in the amount of liquid components. The amount of liquid components included in any particular dough composition can depend on a variety of factors including the desired moisture content of the dough composition. Typically, for a non-developed dough composition, a liquid component may be present in an amount between about 15 and about 35 weight percent based on total weight of a dough composition, e.g., in an amount in the range from 25 to 35 weight percent.

A dough composition can include a fat ingredient such as an oil or shortening. Examples of suitable oils include soybean oil, corn oil, canola oil, sunflower oil, and other vegetable oils. Examples of suitable shortenings include animal fats and hydrogenated vegetable oils. For non-developed dough compositions, fat may often be used in an amount up to about 20 percent by weight, often in a range from 5 or 10 weight percent up to about 20 weight percent fat, based on total weight of a dough composition.

A dough composition can optionally include one or more sweeteners, either natural or artificial, liquid or dry. Examples of suitable dry sweeteners include lactose, sucrose, fructose, dextrose, maltose, corresponding sugar alcohols, and mixtures thereof.

A dough composition as described herein can be prepared according to methods and steps that are known in the dough and dough product arts. These can include steps of mixing or blending ingredients, folding, lapping, forming, shaping, cutting, rolling, filling, etc., which are steps well known in the dough and baking arts.

The dough composition can be packaged and sold in a form that can be refrigerator-stable. An example of a packaging configuration is a non-pressurized plastic tube, chub, or pouch containing individual portions of a dough composition such as biscuits. Another general example of a low pressure package can include packaging configurations that generally include a rigid material such as a rigid plastic tray and a flexible film portion that closes the tray, optionally but not necessarily including a pressure relief valve. If a valve is included, an example of a valve can be one that will release gas upon the internal pressure of a package reaching an from 1.5 to 2 pounds per square inch (gauge). Any materials and techniques can be used for packaging.

Many commercial biscuit products are packaged and sold in pressurized containers such as cardboard cans. The dough compositions described herein can have the advantage of being capable of being packaged without taking special measures to pressurize the package. Thus, exemplary types of packaging that may be useful can include non-pressurized pouch, tube, or chub packaging, prepared from materials that act as a barrier to gases or water vapor to maintain freshness during periods of refrigerated storage (up to weeks or months). A non-pressurized container means that the packaging is not intended to maintain a pressurized interior space, which means that the interior can be at a pressure that is in the range from 1 to 2 atmospheres, absolute.

According to specific embodiments, the packaging can be flexible, and may be prepared from materials such as paper or polymeric materials, e.g., a polymeric film. A polymeric film may be prepared from generally well-known packaging material polymers such as different polyesters (e.g., PET), nylons, polyolefins (e.g., polyethylene), vinyls, polyalcohols, etc.

According to certain embodiments of the invention, the dough composition can be packaged in an unproofed condition, and can experience limited expansion due to leavening while packaged, e.g., during refrigerated storage. For example, an unproofed dough composition, e.g., having a raw specific volume in the range from 0.9 to 1.2 cc/g, can be placed in a flexible package, optionally with reduced or limited headspace, and optionally wherein the package is sized to accommodate the dough composition after a limited amount of leavening within the package (e.g., the total volume of the package is greater than the volume of the dough having a specific volume of 0.9 to 1.2 cc/g). During refrigerated storage, the unproofed dough composition may experience a limited amount of leavening, e.g., to result in a raw specific volume of up to 1.5 cubic centimeter per gram. The package containing the unproofed dough composition can be flexible but not necessarily stretchable, and if slightly oversized and evacuated to contain folds or wrinkles, or otherwise be of a form, e.g., geometry or shape, or combination of these, can allow an increase in internal volume of the flexible package without substantial stretching of the flexible packaging material, to accommodate an increase in volume of the dough composition while inside the flexible package, during refrigerated storage.

According to one exemplary mode of providing a dough composition in a package, a dough composition can be provided in an un-proofed form, e.g., having a raw specific volume in the range from 0.9 to 1.2 cc/g. The dough composition can be placed in the package, with the package including wrinkling, folding or a shape (optionally by using a vacuum) that allows the dough to expand somewhat within the package during refrigerated storage, e.g., expand to a volume that is up to 50 percent of its volume when packaged, and a raw specific volume that is less than 1.5 cc/g. As a specific example, a number of dough pieces such as biscuits can be placed together into a slightly oversized (e.g., 20, 30, or 50 percent greater volume than the volume of the unproofed dough pieces at packaging) flexible package such as a chub or pouch. The slightly oversized flexible package can be collapsed upon or shaped to conform to the dough pieces, mechanically or with vacuum, to eliminate headspace. The dough composition can be frozen when packaged, if vacuum is used to reduce headspace, because the frozen dough composition is less susceptible to damage. Alternatively the dough can be packaged unfrozen (i.e., at greater than freezing temperatures) if the amount of vacuum or pressure exerted upon the dough does not result in product deformation or malformation upon baking. The package can then be sealed.

According to still other examples of the invention, a modified atmosphere can be included in a low pressure package, to reduce the concentration bf oxygen contained in a package headspace. For example, a package that contains a dough composition as described herein can be flushed with carbon dioxide, nitrogen, or a blend of these, to reduce the concentration of oxygen in a package headspace to a level below 1.5 percent of the total amount of gas.

Exemplary embodiments of the invention are described herein. Variations on the exemplary embodiments will become apparent to those of skill in the relevant arts upon reading this description. The inventors expect those of skill to use such variations as appropriate, and intend for the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated.

Following are examples of dough formulations of the invention.

### Process Description:

First Stage Mixing Cycle: Enzymes (glucose oxidase and xyxlanase) and melted shortening were added to ice chilled water in a mixing bowl. Flour and remaining first stage ingredients were then added to the mixing bowl. The first stage ingredients were mixed at 36 revolutions per minute for 30 seconds followed by mixing at 72 revolutions per minute for 210 seconds.

Second Stage Mixing Cycle: The second stage ingredients (shortening chips, sugar, salt, and leavening agents) were cut into the dough (i.e., the dough was scored with a knife to increase the surface area and the ingredients were then distributed over the dough surface). The dough was then mixed at 36 revolutions per minute for 30 seconds followed by 72 revolutions per minute for 210 seconds.

Sheeting: An approximately 5 kilogram piece of dough was sheeted down to a 10 mm using a Rhondo sheeter. The dough pad was then folded to create three layers (a three fold), turned 90°, and sheeted to 10 mm for a second time.

Cutting and Storage: 63+/−3 gm biscuits were cut from the sheeted dough pad using a 2.875 inch circular cutter. The cut biscuits were then placed onto a parchment paper-lined baking sheet, covered with a plastic bag, and placed into a −10° F. freezer for 24 hours. After 24 hours of −10° F. storage the frozen biscuit pucks were placed into sealed plastic bags to prevent dehydration and were packaged within a 7 day time period.

Packaging: 4.375″×9″ rectangular pouch made with nylon film possessing an EVOH oxygen barrier and LDPE sealant. Pouch was sealed on three sides and fitted with a reed valve from Plitex designed to release pressure (gas) at 1.5 pounds per square inch. Frozen dough pucks were packaged two ways—vacuum packaged or vacuum packaged and then back flushed with CO₂ gas to deliver 66 cc headspace using a Multivac C-500 FFS (form fill and seal) packaging machine. The dough puck in contact with the valve was wrapped in parchment paper to prevent fouling. The packaged product was stored at 45° F. and evaluated periodically over 77 days for shelf life stability and bake performance.

In all, a total of 4 dough formulas (0.2, 0.4, 0.6, and 0.8% soda) and two packaging treatments were evaluated for a total of eight separate sample sets.

FTO Premix

| | | |
|---|---|---|
| INGREDIENT | % | Gm |

First Stage Ingredients

| | | |
|---|---|---|
| Flour, hard | 44.113 | 9925. |
| Flour, soft | 0.000 | 0 |
| Water (ice chilled) | 25.333 | 5699. |
| Shortening | 2.000 | 450 |
| Xanthan gum | 0.130 | 29.25 |
| PGA (note 1) | 0.033 | 7.42 |
| Buttermilk solids | 3.000 | 675 |
| 20 DE CSS | 2.250 | 506. |
| Gluzyme (note 2) | 0.001 | 0.225 |
| FTO pre-mix | 0.357 | 80.32 |

Second Stage Ingredients

| Shortening chips | 14.000 | 3150 |
|---|---|---|
| Sugar | 5.500 | 1237.5 |
| SALP | 0.000 | 0 |
| Salt | 1.300 | 292.5 |
| TOTALS: | 98.017 | 22053.83 |
| INGREDIENT | % | gm |
| DATEM | 0.15 | 33.75 |
| Ascorbic acid | 0.005 | 1.125 |
| azodicarbonamide | 0.0019 | 0.427 |
| Sodium stearoyl lactylate | 0.2 | 45 |
| Total | 0.357 | 80.30 |

Process Information

| | |
|---|---|
| F-graph target | 900 +/− 100 BU |
| Dough Temp (° F.) | 65 +/− 5 |
| Mixing Times (sec) | 1st = 30 L + 210 H |
| | 2nd = 30 L + 210 H |
| Cutter diameter (inches) | 2.875″ |
| Freezing | −10° F. for 24 hours |
| | (samples placed on baking sheets lined with |
| | parchment paper and then placed in plastic |
| | bags to prevent dehydration). |

Second Stage Leavening Ingredients

| | | |
|---|---|---|
| INGREDIENT | % | gm |

Run 1

| | | |
|---|---|---|
| soda | 0.200 | 45 |
| SAPP RD1 | 0.278 | 62.55 |

Run 2

| | | |
|---|---|---|
| soda | 0.400 | 90 |
| SAPP RD1 | 0.556 | 125.1 |

Run 3

| | | |
|---|---|---|
| soda | 0.600 | 135 |
| SAPP RD1 | 0.83 | 186.75 |

Run 4

| | | |
|---|---|---|
| soda | 0.800 | 180 |
| SAPP RD1 | 1.11 | 249.75 |

Four sample embodiments of biscuits were prepared according to the invention, including the amounts of soda and SAPP show in the tables directly above. These dough compositions were packaged, and then tested initially and over refrigerated storage in terms of: package volume, headspace composition (CO₂ and O₂); dough density; dough pH; dough color (L, a, b); and baked specific volume

The four tables below clearly show that the RSV for all 8 samples sets remained below 1.5 cc/gm throughout the 77 day study period and that the BSV values for samples made with 0.6-0.8% soda (runs 3, 4, 7, and 8) ranged from 2.6-3.4 cc/gm.

What is claimed is:

1. A refrigerated dough product comprising a raw chemically-leavened dough composition in a low pressure package, the dough composition comprising chemical leavening agent and conditioning agent, the dough composition having a raw specific volume in the range from 0.9 to 1.5 cubic centimeter per gram, wherein the dough composition can be cooked to a specific volume of at least 2.5 cubic centimeter per gram.

2. The product of claim 1 wherein after 40 days of refrigerated storage at 45 degrees Fahrenheit, the dough can be baked to a baked specific volume in the range from 2.5 to 3.5 cubic centimeters per gram.

3. The product of claim 1 wherein the low pressure package is a flexible chub or pouch package, and the package includes a pressure release valve.

4. The product of claim 1 wherein the dough composition comprises a conditioning agent comprises an emulsifier, an oxidant, or both.

5. The product of claim 4 wherein the dough comprises an amount of conditioning agent selected from the group consisting of: at least 0.25% diacetyl tartaric acid esters of mono- and diglycerides, at least 0.001% ascorbic acid, at least 0.01% azodicarbonamide, and at least 0.25% sodium steroyl lactylate, based on the total weight of flour present in the formula.

6. The product of claim 5 wherein the conditioning agent is selected from the group consisting of a diacetyl tartaric acid ester of a monoglyceride, ascorbic acid, azodicarbonamide, sodium stearoyl lactylate, and combinations thereof.

7. The product of claim 1 comprising from 0.2 to 1 weight percent non-encapsulated basic chemical leavening agent.

8. The product of claim 1 comprising acidic chemical leavening agent selected from the group consisting of non-encapsulated sodium aluminum phosphate, non-encapsulated sodium acid pyrophosphate, and combinations thereof.

9. The product of claim 1 wherein the dough is a non-developed, refrigerated, chemically leavened dough.

10. The product of claim 1 wherein the dough is a non-developed dough comprising
from 30 to 50 weight percent flour,
from 5 to 20 weight percent fat,
from 0.2 to 2 weight percent non-encapsulated acidic chemical leavening agent selected from the group consisting of non-encapsulated sodium aluminum phosphate, non-encapsulated sodium acid pyrophosphate, and combinations thereof, and
from 0.1 to 1 weight percent non-encapsulated basic chemical leavening agent,
based on the total weight of the dough composition.

11. The product of claim 10 wherein the dough is a biscuit dough.

12. A method of providing a dough product, the method comprising providing a raw chemically-leavened dough composition comprising chemical leavening agent and conditioner,
placing the raw dough composition in a low pressure package,
storing the dough composition at a refrigerated storage temperature, wherein, during refrigerated storage, the dough does not exhibit a raw specific volume in excess of 1.5 cubic centimeters per gram, and
cooking the dough composition to a specific volume of at least 2.5 cubic centimeter per gram.

13. The method of claim 12 comprising
placing the raw dough composition, having a raw specific volume in the range from 0.9 to 1.2 cubic centimeters per gram, in a dough, into a low pressure dough package sized to accommodate the volume of the dough composition upon expansion during refrigerated storage,
using vacuum to remove headspace from the package,
allowing the dough composition to leaven during refrigerated storage to expand to fill the package without stretching the package.

14. The method of claim 12 wherein after 40 days of refrigerated storage
the dough composition has a raw specific volume in the range from 1 to 1.5 cubic centimeters per gram,
the dough composition can be baked to a baked specific volume in the range from 2.5 to 3.5 cubic centimeters per gram.

15. The method of claim 12 comprising
placing the raw chemically leavened dough composition in a flexible package,
using vacuum to remove air from the dough package, and
sealing the package.

16. The method of claim 15 wherein the dough composition is frozen when placed in the flexible package.

17. The method of claim 12 wherein the dough is a non-developed dough.

18. The method of claim 12 wherein the dough composition is packaged in a flexible film pouch that includes a valve to release gas upon the pouch reaching an internal pressure of 1.5 to 2 pounds per square inch (gauge).

19. The method of claim 12 wherein the dough is a non-developed dough comprising
from 30 to 50 weight percent flour,
from 5 to 20 weight percent fat,
from 0.2 to 2 weight percent non-encapsulated acidic chemical leavening agent selected from the group consisting of non-encapsulated sodium aluminum phosphate, non-encapsulated sodium acid pyrophosphate, and combinations thereof, and
from 0.1 to 1 weight percent non-encapsulated basic chemical leavening agent,
based on the total weight of the dough composition.

20. The method of claim 19 wherein the dough is a biscuit dough.
